(19) United States
(12) Patent Application Publication
(10) Pub. No.: US 2018/0022179 A1
(43) Pub. Date: Jan. 25, 2018

(54) ACTIVE SUSPENSION SYSTEMS

(71) Applicant: BLAGDON ACTUATION RESEARCH LIMITED, Blagdon Bristol (GB)

(72) Inventor: Andrew John COLLINS, Somerset (GB)

(73) Assignee: DOMIN FLUID POWER LIMITED, Blagdon, Bristol (GB)

(21) Appl. No.: 15/548,527

(22) PCT Filed: Feb. 4, 2016
(86) PCT No.: PCT/GB2016/050261

§ 371 Date: Aug. 3, 2017

(30) Foreign Application Priority Data
Feb. 5, 2015 (GB) 1501893.0

(51) Int. Cl. B60G 17/056; B60G 17/04; B60G 17/044; B60G 11/26

(52) U.S. Cl. CPC B60G 17/056; B60G 11/265; B60G 17/0424; B60G 17/044; B60G 2202/154; B60G 2202/416; B60G 2500/203

(57) ABSTRACT

An active suspension system 1 for a vehicle. The suspension system 1 comprises a hydraulic actuator 4 for connection to the vehicle, an accumulator 30 arranged to provide fluid to the actuator 4 and a spool valve 16. The spool valve 16 comprises a spool 18 mounted for movement between a first position in which the flow of fluid from the accumulator 30 to the actuator 4 is prevented and a second position in which fluid can flow from the accumulator 30 to the actuator 4 via the spool 18 thereby causing movement of the actuator 4.

### FIELD OF THE INVENTION

The present invention concerns active suspension systems for vehicles. The invention also concerns a method of actively controlling the suspension of a vehicle, a vehicle including an active suspension system and a strut for use in such a system.

### BACKGROUND OF THE INVENTION

An ‘active’ suspension system for a vehicle may be defined as one in which energy is provided to an actuator in order to control the relative motion of a vehicle wheel and chassis in response to road conditions. This is in contrast to an active damping system (also known as semi-active or adaptive suspension) where the stiffness of the suspension means (for example the stiffness of the damper which is arranged in parallel to the coil spring in a vehicle suspension) is varied in response to road conditions.

It is known to use active suspension systems in vehicles, particularly cars. Such systems typically use a hydraulic actuator to exert a force on the wheel and/or chassis of the vehicle. Typically, in an immediate response to a road event (for example cornering, accelerating or braking) a control system will switch on a pump which supplies fluid at pressure to the actuator in order to move the actuator arm and thereby exert a counter force on the chassis and wheel. Generally, power for the pump is supplied by the vehicle's engine, and consequently including an active suspension system in a vehicle may result in a reduction in the vehicle's overall efficiency. It is therefore desirable to reduce the power used by the active suspension system wherever possible.

FIGS. 1 (a) and 1 (b) show the difference in the force-velocity performance envelope for an active damping system and an active control system respectively. Both figures show Velocity (V) on the horizontal axis and Force (F) on the vertical axis. Each plot has four quadrants: top left (300a), top right (300b), bottom left (300c), bottom right (300d). In FIG. 1 velocity that increases the distance between the wheel and vehicle (i.e. the wheel moving down) is positive, and force directed towards the body of the vehicle (i.e. up) is positive. The top left quadrant 300a therefore represents lifting the wheel, the top right quadrant 300b represent the rebound situation, the bottom left quadrant 300c represents a compression situation and the bottom right quadrant 300d represents pushing the wheel down. In an active damping system (FIG. 1 (a)) the system can only create a force to counteract a movement of the wheel. Thus, the performance envelope 301, the extent of which is denoted by a dashed line in FIG. 1 (a), of an active damping system extends into quadrants 300b and 300c. For an active suspension system (FIG. 1 (b)) the performance envelope 301 extends into all four quadrants as, in addition to producing an opposing force in response to a movement (as occurs in quadrants 300b and 300c), an active suspension system is also capable of producing a force in order to move the wheel (as occurs in quadrants 300a and 300d).

A key challenge for active suspension systems is to provide at short notice the high power output that is required when the vehicle encounters more severe road events, for example speed bumps. Driving a pump at very high rates in order to provide a large amount of pressurised fluid to the actuator in a short time period can result in a significant power draw from the vehicles engine which may impact on the driving experience and which may be inefficient. Large control valves and/or pumps may also be required in order to produce a sufficiently high flow rate. The extra space required and/or additional mass introduced as a result of such large valves/pumps may be undesirable where space is limited and additional mass can impact unfavourably on vehicle efficiency.

One way in which this problem has been approached is to use forward looking sensors to observe the road conditions ahead and to anticipate when the active suspension system may be required to operate. An example of this type of system is the Mercedes-Benz Magic Body Control® system. By anticipating further in advance that the active suspension system will be required, fluid can be provided to the actuator over a longer period of time thereby reducing the maximum power drain on the vehicle and reducing the size of the pumps/valves required. However, such forward-sensing systems are often complex and involve additional hardware costs, limiting their use to top-of-the-range vehicles.

The present invention seeks to mitigate the above-mentioned problems. Alternatively or additionally, the present invention seeks to provide an improved active suspension system and method of using such a system.

### SUMMARY OF THE INVENTION

The present invention provides, according to a first aspect, an active suspension system for a vehicle, the suspension system comprising a hydraulic actuator for connection to the vehicle, an accumulator arranged to provide fluid to the actuator and a spool valve comprising a spool mounted for movement between a first position in which the flow of fluid from the accumulator to the actuator is prevented and a second position in which fluid can flow from the accumulator to the actuator via the spool thereby causing movement of the actuator.

Using a spool valve to control the flow of fluid between the accumulator and the actuator may result in increased flow rates as compared to similar systems using other types of valves of a similar size and/or mass.

Using a spool valve to control the flow of fluid between the accumulator and the actuator may reduce the quiescent losses of the system as compared to similar systems employing other types of valves.

The accumulator may form part of a high-pressure sub-system. The high-pressure sub-system may be arranged to provide high-pressure fluid to the actuator. The active suspension system may also comprise a low-pressure sub-system. The low-pressure sub-system may be arranged to receive fluid from the actuator and/or to provide fluid to the high-pressure sub-system. It will be appreciated that the terms high-pressure and low-pressure sub-system are used herein to indicate the pressure of the two sub-systems relative to each other. That is to say, fluid pressure in the high-pressure sub-system may be higher than fluid pressure in the low-pressure sub-system. Similarly, high-pressure fluid is used to refer to fluid from the high-pressure sub-system, i.e. fluid that is at higher pressure than that in the low-pressure sub-system. It will be appreciated that the pressure required in the high and low-pressure sub-systems will depend, at least in part, on the size of the vehicle and the drive performance required. It will also be appreciated that the pressure in both sub-systems may vary during operation of the active suspension system as fluid enters or leaves each sub-system.

The low-pressure sub-system may be pressurised at between 10 psi (0.07 MPa) and 3000 psi (20.69 MPa). The high-pressure sub-system may be pressurised at between 500 psi (3.45 MPa) and 5000 psi (34.48 MPa). The difference in pressure between the high-pressure sub-system and the low-pressure sub-system may be between 500 psi (3.45 MPa) and 4000 psi (27.58 MPa).

It may be that, when the spool is in the second position, fluid can flow from the actuator to the low-pressure sub-system via the spool.

Providing a spool valve with a spool mounted for movement to a second position as described above may allow a single valve to simultaneously control the flow of fluid to and from the actuator thereby reducing the complexity of the active suspension system.

The active suspension system may include a plurality of flow galleries arranged to provide one or more flow paths between the components of the system.

The accumulator may form part of the high-pressure sub-system. Thus, when the spool is in the second position fluid may flow from the high-pressure sub-system to the actuator via the spool. The accumulator may be located upstream, for example immediately upstream of the control valve, for example the spool valve. The accumulator may be connected to the control valve, for example the spool valve, by a flow gallery. In use, fluid may flow from the accumulator to the control valve via a flow gallery without passing through another component of the active suspension system.

The actuator may comprise a main body and an actuator arm located at least partly within the main body and mounted for movement relative to the main body. A first end of the actuator arm may be located within the main body. The first end of the actuator arm may form a piston head which divides a cavity formed within the actuator body into two chambers. The first actuator chamber may be located on the same side of the piston head as the rest of the actuator arm. The second actuator chamber may be located on the opposite side of the piston head to the rest of the actuator arm. The second end of the actuator arm may be suitable for connection to the chassis of a vehicle. The second end of the actuator arm may be suitable for connection to the wheel assembly of a vehicle.

It may be that when the spool is in the second position fluid can flow from the accumulator to the first actuator chamber via the spool thereby increasing the pressure in the first actuator chamber.

It may be that when the spool is in the second position fluid can flow from the second actuator chamber to the low-pressure sub-system via the spool thereby reducing the pressure in the second actuator chamber.

It will be appreciated that by balancing the pressure forces in the chambers on either side of the piston the movement of the actuator arm, and thereby the movement of the wheel relative to the chassis, may be controlled. It will further be appreciated that the direction of the relative movement of the wheel will depend on the orientation of the actuator with respect to the chassis and/or wheel.

It may be that the spool is mounted for movement between the first position and a third position in which fluid can flow from the hydraulic actuator to the low-pressure sub-system via the spool and wherein the flow of fluid from the high-pressure sub-system to the hydraulic actuator is prevented by the spool when the spool is in the third position.

Where the spool is moved only between the first and third positions the active suspension system may be said to be in a ‘semi-active’ mode as no energy is being provided to the actuator; instead the ‘stiffness’ of the actuator is varied by allowing fluid to escape from one of the actuator chambers. Providing a spool mounted for movement to a third position as described above allows the active suspension system to operate in a ‘semi-active’ mode without consuming significant amounts of fluid from the high-pressure sub-system. Allowing the active suspension system to function in a ‘semi-active’ mode for less severe road events may therefore reduce the amount of high-pressure fluid used and thereby increase the efficiency of the active suspension system.

Providing a spool mounted for movement between a first, second and third position as described above may allow a single spool valve to control the active suspension system when it is in ‘active’ and ‘semi-active’ modes. Using a single spool valve to control the active suspension system in both ‘active’ and ‘semi-active’ modes may facilitate the design of less complex active suspension systems.

It may be that when the spool is in the third position fluid cannot flow from the accumulator to the hydraulic actuator. It may be that when the spool is in the third position fluid can flow from the second actuator chamber to the low-pressure sub-system thereby reducing the pressure in the second chamber.

The spool may be mounted for movement in a first direction from the first position towards the second position. The spool may be mounted for movement in the first direction from the first position towards the third position. It may be that the spool passes through the third position when the spool moves from the first position to the second position. Thus, an active suspension system in accordance with the present invention may switch from a ‘semi-active’ to an ‘active’ state by simply increasing the excursion of the spool in the first direction thereby reducing the number of components in, and complexity of, the active suspension system.

An accumulator may be defined as a reservoir in which a fluid is held under pressure. The accumulator may be linked to the control valve by a flow gallery. It may be that the cross-sectional area of the accumulator is significantly larger than the cross-sectional area of the flow gallery. For example, it may be that the cross-sectional area of the accumulator is two, three, four or more times the cross-sectional area of the flow gallery.

It may be that the fluid in the accumulator is held under pressure by an external source. Thus the accumulator may include a cavity and an external source arranged to exert a force on fluid contained in the cavity. The external source may comprise a spring, a weight and/or a compressed gas arranged to exert a force on fluid in the cavity.

Providing an accumulator may allow a reserve of pressurised fluid to be built up over a period of time prior to the detection of a road event. Gradually building up the pressure in the high-pressure sub-system may allow the size of any pump and/or the power requirements of the active suspension system to be reduced.

It may be that the active suspension system includes a reservoir arranged to increase the volume of fluid retained in the high or low-pressure sub-system.

It may be that the suspension system comprises a pump. The pump may be arranged to provide high pressure fluid to the accumulator. The accumulator may be located downstream of the pump. In use, fluid may flow to the control valve, for example the spool valve, from the pump via the accumulator. The pump may be arranged to provide fluid from the low-pressure sub-system to the high-pressure sub-system. The accumulator may be connected to a flow path that extends between the pump and the control valve, for example the spool valve. It may be that accumulator is located directly on the flow path, or joined by a flow gallery to the flow path. The pump may be a radial piston pump.

Providing an accumulator between the pump and the spool allows high-pressure fluid to be provided to the accumulator in advance of a road event. Accumulating a reserve of high-pressure fluid before it is required by the actuator may allow a smaller pump to be used and may reduce the maximum power required by the active suspension system.

Having a high-pressure sub-system where an accumulator is located between a pump and the control valve and the control valve is a spool valve may be particularly beneficial as a spool valve may provide a lower level of quiescent leakage from the high-pressure sub-system as compared to other types of valve thereby reducing the amount of high-pressure fluid (and therefore energy) that is lost from the active suspension system without doing any useful work.

The control valve may be directly connected to the accumulator. The control valve may be directly connected to the actuator, for example the main body of the actuator. A first component may be said be directly connected to a second component if no third component (including flow galleries) is located between the first and second component. For example, an outlet of the control valve may be connected to an inlet of the actuator such that fluid flows from the control valve to the actuator without passing through any other component. An outlet of the accumulator may be connected to an inlet of the control valve such that fluid flows from the accumulator to the control valve without passing through any other component.

It may be that the spool valve is a direct drive spool valve (DDV). A DDV may be defined as a valve in which the motor is directly connected to the spool.

Using a DDV valve may reduce quiescent leakage from the high-pressure sub-system as compared to other types of spool valve thereby assisting in maintaining the pressure in the high-pressure sub-system while reducing the power demand on the rest of the vehicle's systems.

The spool valve may be an Electro-Hydraulic Servo Valve (EHSV) comprising a pilot stage and a main (or primary) stage including the spool. The EHSV may be a traditional EHSV valve using a jet nozzle or flapper in the pilot stage.

The spool may be mounted for movement between the first position and a fourth position in which fluid can flow from the accumulator to the actuator via the spool. It may be that fluid can also flow from the actuator to the low-pressure sub-system via the spool when the spool is in the fourth position. It may be that where fluid flows from the accumulator to one of the first or second actuator chambers when the spool is in the second position the fluid flows from the accumulator to the other of the first or second actuator chambers when the spool is in the fourth position. It may be that, where fluid flows from the first or second actuator chambers to the low-pressure sub-system when the spool is in the second position, the fluid flows from the other of the first or second actuator chambers to the low-pressure sub-system when the spool is in the fourth position. The spool may be mounted for movement in a second direction, opposite to the first direction, from the first position towards the fourth position.

Providing a spool mounted for movement between a first position, second position and fourth position as described above may therefore facilitate the design of active suspension systems which can actively control the relative movement of a wheel relative to the chassis of the vehicle in two directions using a single spool valve.

The spool may be mounted for movement between the first position and a fifth position in which fluid can flow from the hydraulic actuator to the low-pressure sub-system via the spool valve and wherein the flow of fluid from the high-pressure sub-system to the hydraulic actuator is prevented by the spool when the spool is in the fifth position. Movement of the spool in the second direction from the first position may move the spool towards the fifth position. It may be that the spool passes through the fifth position when it moves between the first position and the fourth position.

Providing a spool mounted for movement between a first, second, third, fourth and fifth positions as described above may therefore facilitate the design of active suspension systems which can actively and semi-actively control the relative movement of a wheel relative to the chassis of the vehicle in two directions using a single spool valve and/or a single spool thereby reducing the complexity of the system.

The spool valve may include a plurality of internal ports arranged such that, in use, fluid may flow through the spool valve via the internal ports. The spool valve may include a manifold. The spool may be mounted for movement relative to a manifold. The inner surface of the manifold may define a cavity within which the spool is located. The internal ports may be formed on the inner surface of the manifold which defines the cavity. The spool valve may include a plurality of internal ports arranged to allow fluid to flow into and/or out of the internal cavity. Thus, the relative movement of the spool and the manifold may control the flow of fluid through the valve. The spool valve may include a motor arranged to move the spool directly (for example in a DDV) or indirectly (for example via a nozzle, flapper and/or secondary spool in an EHSV).

The outer surface of the spool may include at least one groove. The at least one groove may extend around the circumference of the spool. The spool may include at least one land. In use, depending on the position of the spool the lands may close off an internal port. In use, depending on the position of the spool, fluid may flow between internal ports via the at least one groove in the outer surface of the spool. The spool may be substantially cylindrical.

Categories of internal ports include high-pressure ports, return ports and service ports.

The spool valve may include at least one high-pressure port. Fluid may flow from the accumulator into a groove on the outer surface of the spool via the high-pressure port. Each high-pressure port may form part of the high-pressure sub-system such that high-pressure fluid may be provided to the actuator via a high-pressure port.

The spool valve may include at least one return port. Fluid may flow out of a groove on the outer surface of the spool via a return port. Each return port may form part of the low-pressure sub-system such that fluid may flow from the actuator to the low-pressure sub-system via a return port.

The spool valve may include at least two service ports. Fluid may flow between the actuator and the spool via the service ports. Fluid may flow into or out a groove on the outer surface of the spool via a service port. Thus, a service port may act as a fluid inlet or a fluid outlet depending on the position of the spool.

A corresponding port may be defined as a second port which lies upstream or downstream of a first port on a flow path for at least one position of a spool. Thus, fluid may flow into or out of the groove via a first port and into or out of the groove via a corresponding port. A service port may have a corresponding return port (and vice versa). A service port may have a corresponding high-pressure port (and vice versa). For example, when the spool is in the second position, fluid may flow from the accumulator to the actuator via a high-pressure port and a corresponding one of the at least two service ports and from the actuator to the low-pressure sub-system via the other of the at least two service ports and a corresponding return port.

The internal ports of the spool valve may be spaced apart along the longitudinal axis of the spool. The ports and spool may be arranged such that the distance that the spool must move in a first direction to create a flow path between a service port and the corresponding return port is less than the distance the spool must move in the same direction to create a flow path between another service port and its corresponding high-pressure port.

It may be that the spool and ports are arranged such that the distance moved by the spool in a first direction to form a flow path between a service port and the corresponding return port is less than the distance moved by the spool in the opposite direction to form a flow path between the service port and the corresponding high-pressure port. That is to say, the spool and ports may be arranged such that the spool passes through a third position when the spool moves from the first position to the second position. Arranging the spool and ports in this manner may facilitate designs in which the active suspension system moves between ‘active’ and ‘semi-active’ modes depending on the degree of excursion of the spool.

It may be that the distance between a groove and the nearest return port (along the longitudinal axis of the spool) is less than the distance between the groove and the nearest high-pressure port. It may be that the distance between a service port and the nearest return port (along the longitudinal axis of the spool) is less than the distance between the service port and the nearest high-pressure port. A service port may be located closer to its corresponding return port along the longitudinal axis of the spool than its corresponding high-pressure port. The internal ports of the spool valve may be spaced apart around the circumference of the spool.

It may be that the internal ports of the spool valve are arranged relative to the spool such that when the spool is the first position the service ports are closed off by the lands of the spool but the high-pressure port and/or the return ports are open to the groove(s). Thus, it may be that flow through the spool valve is regulated by moving the spool to modulate the flow through the service ports while the high-pressure port and/or return ports remain substantially open.

It may be that the internal ports of the spool valve are arranged relative to the spool such that when the spool is in the first position the high-pressure port and/or the return ports are closed off by the lands of the spool but the service ports are open to the groove(s). Thus, it may be that flow through the spool valve is regulated by moving the spool to modulate the flow through the high-pressure port and/or return ports while the service ports remain substantially open.

The active suspension system may include at least one check valve arranged to allow the flow of fluid from the actuator to the low-pressure sub-system. For example, the active suspension system may include two, three, four or more check-valves arranged to allow the flow of fluid from the actuator to the low-pressure sub-system. Providing such check valves may assist in preventing cavitation.

The active suspension system may include a bootstrap reservoir connected to the low-pressure sub-system. Providing a bootstrap reservoir may help to maintain a constant pressure at the pump inlet thereby reducing the risk of cavitation. The bootstrap reservoir may include a piston extending between the low-pressure sub-system and the high-pressure sub-system. A first face of the piston may be arranged to exert pressure on fluid contained in the low-pressure sub-system. A second face of the piston may be arranged to exert pressure on fluid contained in the high-pressure sub-system. The surface area of the first face may be substantially greater than the surface area of the second face. For example the surface area of the first face may be more than 20%, more than 40% or more than 50% greater than the surface area of the second face. The bootstrap reservoir may be concentrically located with respect to the actuator arm and/or the accumulator (if present) in the strut.

It may be that the active suspension system comprises a strut arranged for connection between the chassis and the wheel of the vehicle. It may be that the accumulator, bootstrap reservoir, and/or actuator are located in the strut. It may be that the control valve and/or pump are located in the strut.

Alternatively it may be that the control valve and/or pump are provided in a separate control module. It may be that the control valve (for example the spool valve) and the pump are formed as a single component using an additive manufacturing process. The control module may have a diameter of between 50 and 150 mm. The control module may have a height of between 50 and 200 mm.

The active suspension system may include a plurality of sensors arranged to detect acceleration of the vehicle. It may be that at least one sensor, for example an accelerometer, is located forward of a wheel arch of the vehicle. It may be that a sensor is located forward of each wheel arch of the vehicle. It may be that at least one sensor, for example an accelerometer, is connected to a wheel of the vehicle. It may be that a sensor is connected to each wheel.

The active suspension system may include a control system arranged to control the provision of power to the pump and/or the movement of the spool in response to a signal received from the sensors. The control system may be arranged to operate the active suspension system in a ‘semi-active’ mode wherein the control system controls movement of the spool between the first, third and/or fifth positions. The control system may be arranged to operate the active suspension system in an ‘active’ mode wherein the control system controls movement of the spool between the first, second and/or fourth positions. The suspension system may comprise a control system arranged to switch the system between a ‘semi-active’ mode and an ‘active’ mode in response to the severity of a road event. It will be appreciated that the control system may switch the active suspension system between and ‘active’ and ‘semi-active’ mode simply by increasing the excursion of the spool in response to the signal(s) received from the sensor(s).

The active suspension system may include a pump motor arranged to drive the pump.

The active suspension system may include a control valve motor arranged to alter the position of the control valve, for example the spool.

The spool may be located in the cavity such that there is substantially no gap between the outer surface of the spool where a groove is not present and the inner surface of the manifold where the internal ports are not present. The majority of the surface of the inner sleeve may be in contact, as herein defined, with the inner surface of the manifold. “in contact” as herein defined means that any gap between the two components in question is small enough that internal leakage of fluid is less than 5% of the flow through the valve. Therefore fluid flow around the spool, other than via the grooves, may be prevented. Thus, contact between the spool and the inner surface of the manifold may be defined as the two surfaces being sufficiently close together to prevent significant flow between them. For example, the clearance between the spool and the inner surface of the manifold may be between 1.5 μm and 2.5 μm, or less than 5 μm. In this way precise control of the fluid flow through the valve is achievable, as the amount of flow is the result of the degree of alignment between the grooves and the fluid inlet/outlet. The spool valve may include a sleeve to assist in balancing pressure forces within the valve. Such sleeves are well known and will not be discussed further here. Where reference is made herein to the inner surface of the manifold, this includes the inner surface of a sleeve if present.

In use, the actuator of the suspension system may be capable of producing 10 to 50 kW of power in order to deal with a severe road event such as a speed bump. The actuator may deliver that power within 5 to 50 ms of a speed bump being detected.

In use, the flow rate through the spool valve may be in the range of 50 to 200 litres per minute. The spool may have a mass of between 2 and 50 g. The spool may have a diameter of between 5 and 15 mm.

The pump may be capable of achieving flow rates of 0.1 to 10 litres/minute.

While the discussion above may refer to a first, second, third, fourth or fifth position, it will be appreciated that such positions do not described a single location of the spool relative to the manifold. In each of the second, third, fourth or fifth position there is a continuum of spool locations which make up each position. Providing such a spool valve may allow the flow rate through the valve to be controlled by varying the area of a port which is uncovered when the spool is in a particular position.

In use, the actuator may be attached to a vehicle. The second end of the actuator arm may be connected to the chassis. The end of the actuator opposite to the second end of the actuator arm may be connected to a wheel. In the case that the actuator is so connected to the vehicle, the first actuator chamber may be closer to the chassis of the vehicle than the second actuator chamber. Thus, it may be that providing high-pressure fluid to the first actuator chamber while allowing fluid to escape from the second actuator chamber causes the wheel to lift up (i.e. move closer to the chassis). Allowing fluid to escape from the second actuator chamber when the control valve is in the closed position may slow the rate at which the wheel moves towards the chassis when subjected to an external force and/or moves the wheel away from the chassis towards its normal position following a road event. Providing high-pressure fluid to the second actuator chamber while allowing fluid to escape from the first actuator chamber may cause the wheel to be move downwards (i.e. move further from the chassis). Allowing fluid to escape from the first actuator chamber when the control valve is in the closed position may slow the rate at which the wheel moves away from the chassis when subjected to an external force and/or to move the wheel towards the chassis and its normal position following a road event. It will be appreciated that the actuator may be attached to the vehicle the other way round and the relationship between the flow of fluid to the actuator chambers and the movement of the wheel will be reversed as compared to that described above.

The hydraulic fluid may be an incompressible fluid, for example an oil. Such fluids are well known and will not be discussed further here.

Examples of a severe road event may include travelling over a speed bump or a curb at speeds in the region of 20 to 30 mph. A speed bump may have a maximum height of around 100 mm, a minimum length of 900 and a ramp gradient of not more than 1:10. Severe road events may involve accelerations of 0.1 to 1 g. Examples of moderate road events may include low-speed cornering or travelling over minor imperfections in a road surface. Moderate road events may involve accelerations of less than 0.1 g.

According to a second aspect of the invention there is provided a method of actively controlling the suspension of a vehicle using an active suspension system, the suspension system comprising a spool valve including a spool, an accumulator and a hydraulic actuator, the method comprising the step of moving the spool from a first position to a second position to alter the flow of fluid to the actuator from the accumulator in response to a road event.

The method may include the step of detecting a road event, for example a severe road event, for example a speed bump, and moving the spool from the first position to the second position in response to that event.

The method may include the step of moving the spool from the first position to the third position in order to allow fluid to escape from a chamber of the actuator while preventing the supply of high-pressure fluid to the actuator. The method may include the step of detecting a moderate road event, for example a corner, and moving the spool from the first position to the third position in response to that event.

The method may further include the step of moving the spool between the first and fourth or fifth positions in response to severe and moderate road events respectively.

The method may include the step of operating the pump to provide pressurised fluid to the accumulator while the spool is in the first position. The method may include the step of monitoring the pressure in the high-pressure sub-system when the spool is in the first position. The method may include the step of periodically operating the pump to provide pressurised fluid to the accumulator while the spool is in the first position in order to maintain the pressure in the high-pressure sub-system. Thus, the method may include operating the pump to provide pressurised fluid to the high-pressure sub-system before a road event has been detected.

When a road event has been detected the method may include categorising the event as moderate or severe and switching the active suspension system into an ‘active’ or ‘semi-active’ mode as appropriate by moving the spool to one of the second/fourth positions or the third/fifth positions.

The method may include the step of operating the pump to provide pressurised fluid to the accumulator and/or directly to the spool valve when the spool is in the second and/or fifth position during a severe road event.

The method may include the step of operating the pump to provide pressurised fluid to the accumulator following a road event, for example a severe road event. Thus, the method may include operating the pump to (i) maintain pressure in the high-pressure sub-system prior to any road event, (ii) provide additional pressurised fluid to the actuator during a road event and (iii) repressurise the high-pressure sub-system following a road event.

The method may include the step of lifting the wheel up by providing high pressure fluid from the high-pressure sub-system to the first actuator chamber. The step of lifting the wheel up may include allowing fluid to escape from the second actuator chamber. The method may include the step of returning the wheel to its normal position after it has been lifted. This step may include allowing fluid to escape from the first actuator chamber when the control valve without supplying high-pressure fluid to the second actuator chamber.

The method may include the step of lowering the wheel by providing high pressure fluid from the high-pressure sub-system to the second actuator chamber. Lowering the wheel may include allowing fluid to escape from the first actuator chamber. The method may include the step of returning the wheel to its normal position after it has been lowered. This step may include allowing fluid to escape from the second actuator chamber without supplying high-pressure fluid to the first actuator chamber.

The method may include the step of slowing the rate at which the wheel moves towards the chassis in response to an external force acting on the wheel. Slowing the rate at which the wheel moves towards the chassis may include allowing fluid to escape from the first actuator chamber without supplying high-pressure fluid to the second actuator chamber.

The method may include the step of slowing the rate at which the wheel moves away from the chassis in response to an external force acting on the wheel. Slowing the rate at which the wheel moves away from the chassis may include allowing fluid to escape form the second actuator chamber when the control valve is in the closed position without supplying fluid to the first actuator chamber.

The method may include that step of producing at least part of the active suspension system using an additive manufacturing process. The method may include the step of producing the strut using an additive manufacturing process. The method may include the step of producing a strut including at least part of one or more of the following elements of the active suspension system as a single component using an additive manufacturing process; the actuator, the accumulator, the control valve, for example the spool valve.

The method may include the step of producing the pump and the control valve as a single component using an additive manufacturing process.

The method may include a step of modifying the ride height of a vehicle using an active suspension system as described herein.

A target position of the actuator arm may be defined as the position of the actuator arm relative to the actuator housing which the actuator arm adopts in the absence of external force due to road events. Thus, the target position of the actuator arm determines the ride height of the vehicle.

The method may include setting a first target position of the actuator arm relative to the actuator housing and moving the spool between the first and one of the second or third positions to control the movement of the actuator arm relative to the first target position. The method may include moving the spool from the first position to one of the second or third positions such that fluid can flow to and/or from the actuator via the spool thereby causing movement of the actuator arm from the first target position to a second target position. Once the actuator arm has attained the second target position the method may include moving the spool between the first and one of the second or third positions to control the movement of the actuator arm relative to the second target position. The control system of the active suspension system may be arranged to alter the target position of the actuator arm from a first target position to a second target position thereby changing the ride height of the vehicle. Controlling the ride height of the vehicle using the active suspension system may avoid the need for a separate mechanism for controlling ride height thereby reducing complexity and/or cost.

According to a third aspect of the invention there is provided a method of controlling the movement of the wheel of a vehicle using an active suspension system comprising a hydraulic actuator suitable for connection between a wheel and the chassis of the vehicle, a control valve arranged to control the flow of fluid to the actuator, an accumulator in fluid communication with the control valve and a pump arranged to provide fluid to the accumulator, the method comprising moving the control valve from a closed position in which fluid cannot flow from the accumulator to the actuator to an open position in which fluid can flow from the accumulator to the actuator via the valve in response to a road event, and wherein the method further includes operating the pump to provide high pressure fluid to the accumulator when the control valve is in the closed position.

Providing high pressure fluid to the accumulator when the control valve is in the closed position allows the pressure in the accumulator to be gradually increased over a long period of time. Gradually increasing the pressure in the accumulator may reduce the size of pump required and/or the amount of power drawn by the active suspension system. The gradual increase in pressure may also reduce the need for systems designed to anticipate upcoming road events thereby reducing the complexity of active suspension system.

The method may include the step of periodically operating the pump to provide high pressure fluid to the accumulator when the control valve is in the closed position in order to maintain pressure in the high-pressure sub-system. An active suspension system may be said to be in ‘standby’ mode when the control valve is in the closed position and the pump is periodically operated to maintain fluid pressure in the high-pressure sub-system. It may be that the active suspension system is in ‘standby’ mode for the majority of the time that the vehicle is in motion. For example the active suspension system may be in ‘standby’ for more than 90%, for example more than 95% of the time that the vehicle is in motion. It may be that the active suspension system only moves from ‘standby’ to ‘active’ in response to some road events, for example for severe road events such as speed bumps. It may be that the active suspension system is moves from ‘stand-by’ mode to ‘semi-active’ mode for the majority of road events.

According to a fourth aspect of the invention there is provided an active suspension system for a vehicle, the active suspension system comprising a hydraulic actuator for connection between a wheel and the chassis of the vehicle, a control valve arranged to control the flow of fluid to the actuator, a high pressure sub-system including an accumulator in fluid communication with the control valve and a pump arranged to provide high pressure fluid to the high pressure sub-system.

The active suspension system may include a low-pressure sub-system arranged to supply fluid to the pump and to receive fluid from the actuator via the spool valve.

The control valve may be a spool valve.

According to a fifth aspect of the invention there is provided a strut arranged for connection between the chassis and a wheel of a vehicle wherein the strut comprises a main housing, the main housing forming at least part of one of the components of the active suspension system according to, or for use in the method of, any other aspect.

The main body of the actuator, for example an actuator chamber, may be formed at least in part by the main housing of the strut. Thus, the actuator of the active suspension system may form part of a strut arranged for location between the chassis and the wheel of the vehicle.

The accumulator may be formed at least in part by the main housing of the strut. Thus, at least part of the accumulator and the main body of the actuator may be formed as a single component in the housing of the strut. The accumulator may be concentrically located with the actuator chamber. The accumulator may extend around a portion of the circumference of the actuator chamber.

The bootstrap reservoir may be formed at least in part by the housing of the strut. The control valve may be formed at least in part by the main housing of the strut. The spool valve, for example the spool valve manifold, may be formed at least in part by the main housing of the strut. The pump may be formed at least in part by the main housing of the strut. Thus, it may be that at least part of one or more of the main body of the actuator, the accumulator, the bootstrap reservoir, the pump and/or the spool valve are formed as a single component in the housing of the strut. It may be that the flow galleries linking one or more of the elements of the active suspension system are also formed as a single component with some of those elements in the housing of the strut.

Providing other elements of the active suspension system, in addition to the actuator, in the strut may facilitate the design of active suspension systems which are easier to install and maintain (as the strut can simply be replaced as a single unit) and/or which are more compact.

It may be that the strut or at least part of the strut, for example the main housing of the strut, is produced using an additive manufacturing process.

Using an additive manufacturing process to produce a strut comprising at least one element of the active suspension system may facilitate more compact strut designs and/or reduce the costs of producing such struts as compared to struts produced using traditional manufacturing methods.

According to a sixth aspect of the invention, there is provided a vehicle comprising an active suspension system according to, or for use in the method of, any other aspect.

The vehicle may be a road vehicle, for example a car, truck or heavy goods vehicle (HGV). The vehicle may be a train, a tank or any one of a wide range of vehicles requiring suspension. The vehicle may have more than one wheel. The vehicle may have a hydraulic actuator associated with each wheel. Each hydraulic actuator may form part of an active suspension system. It may be that other components of the active suspension system (the servo valve, the accumulator, the pump (if present), the bootstrap reservoir (if present), and/or the motor (if present)) are located locally to each hydraulic actuator. It may be that a different control valve, for example a different spool valve is arranged to control the supply of fluid to each actuator. It may be that a different accumulator is arranged to provide high-pressure fluid to each actuator. It may be that a different pump is arranged to supply fluid to the high-pressure sub-system, including the accumulator, associated with each actuator.

Alternatively, it may be that in some cases it is advantageous to have a central pump arranged to supply pressurized fluid to the high-pressure sub-system associated with each actuator.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIGS. 1(a) and (b) show schematic plots of the force-velocity performance envelope for (a) an active damping system and (b) an active suspension system;

FIG. 2 shows a schematic view of an active suspension system according to a first embodiment of the invention;

FIGS. 3 (a), (b) and (c) show a close up of part of the servo valve of the active suspension system according of the first embodiment when the spool is in (a) a null position, (b) a intermediate position and (c) an extended position;

FIG. 4 shows a flow chart of a method of controlling the movement of the wheel of a vehicle using the active suspension of the first embodiment;

FIG. 5 shows a strut for use in an active suspension system according to a second embodiment of the invention; and

FIGS. 6 (a) and (b) show schematic plan views of a car including an active suspension system according to a further embodiment of the invention.

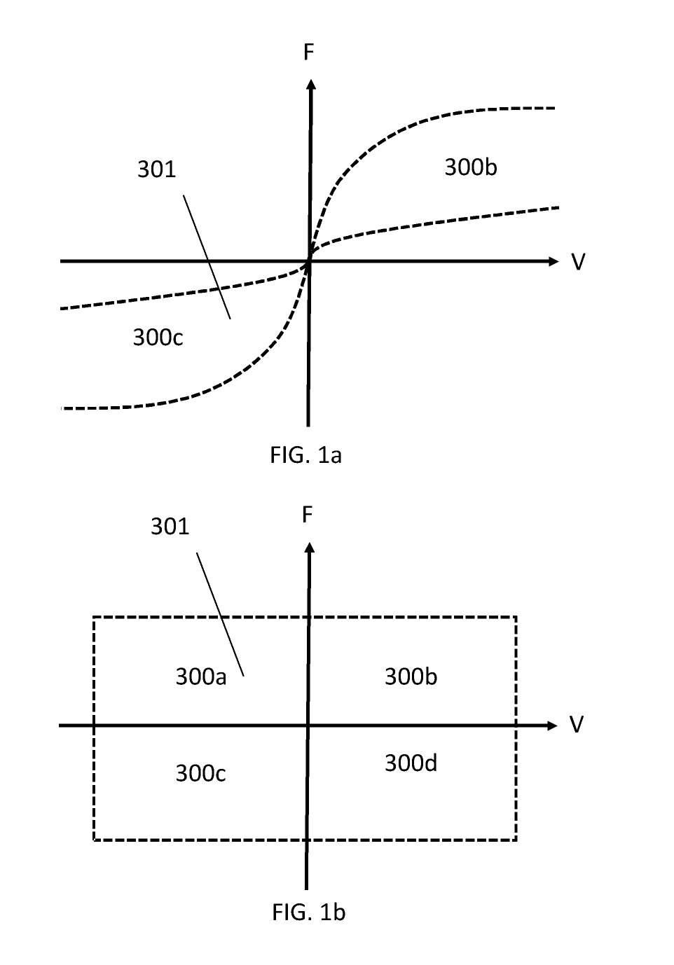

### DETAILED DESCRIPTION

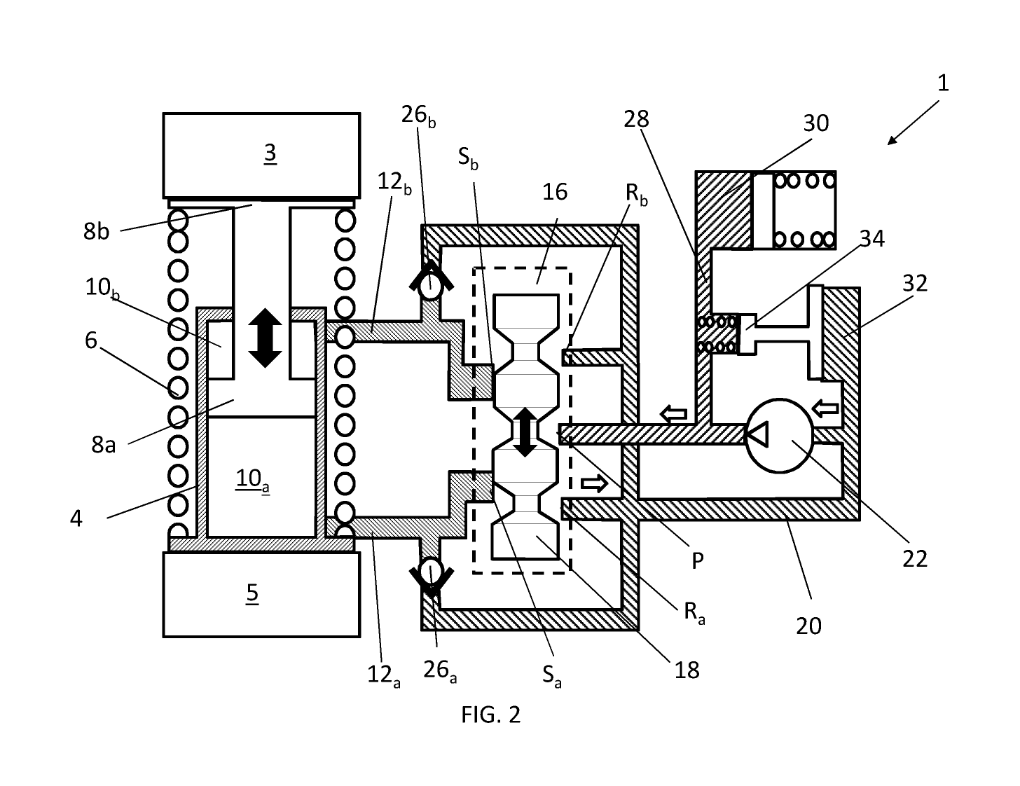

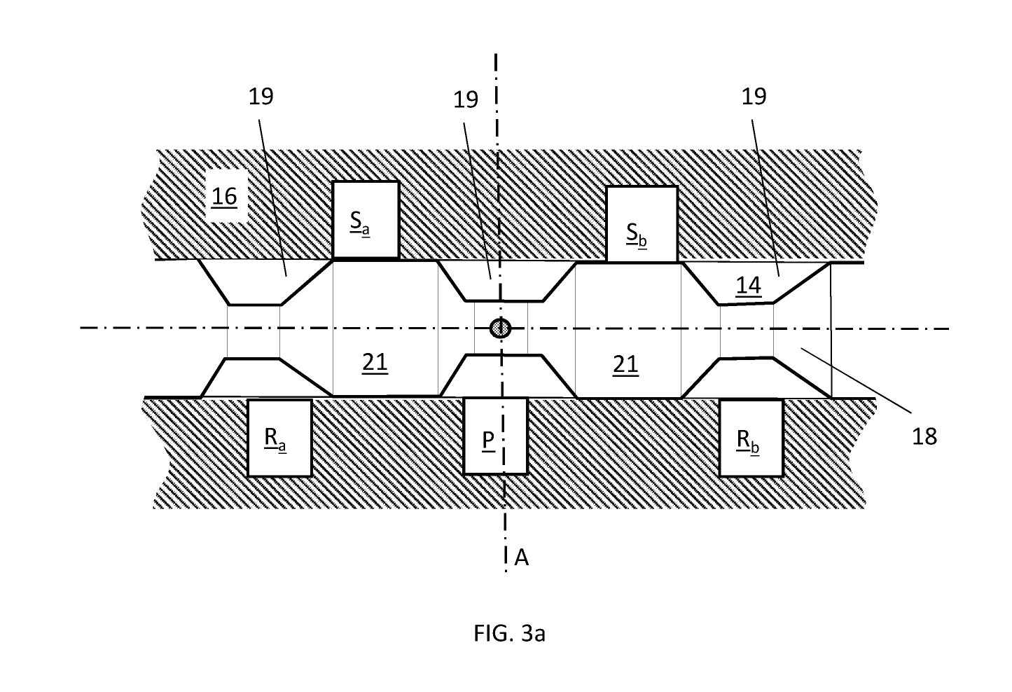

FIG. 2 shows a cross-sectional schematic view of an active suspension system 1 according to a first example embodiment of the invention. The active suspension system 1 includes a hydraulic actuator 4 concentrically located with a coil spring 6. The actuator 4 is connected to the chassis 3 of a car at one end and to a wheel 5 of the car at the other end.

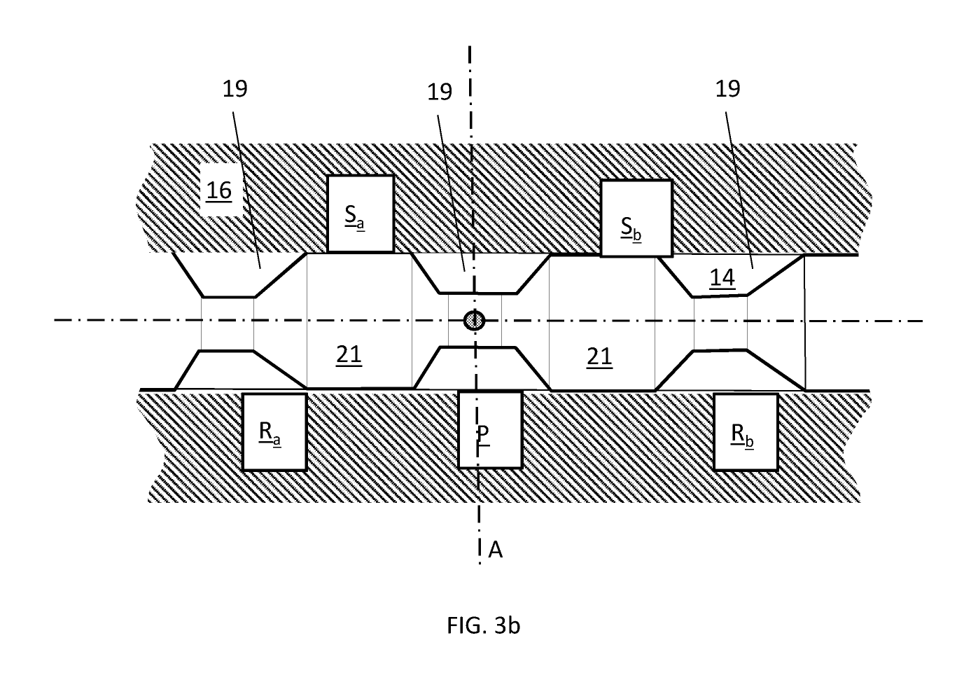

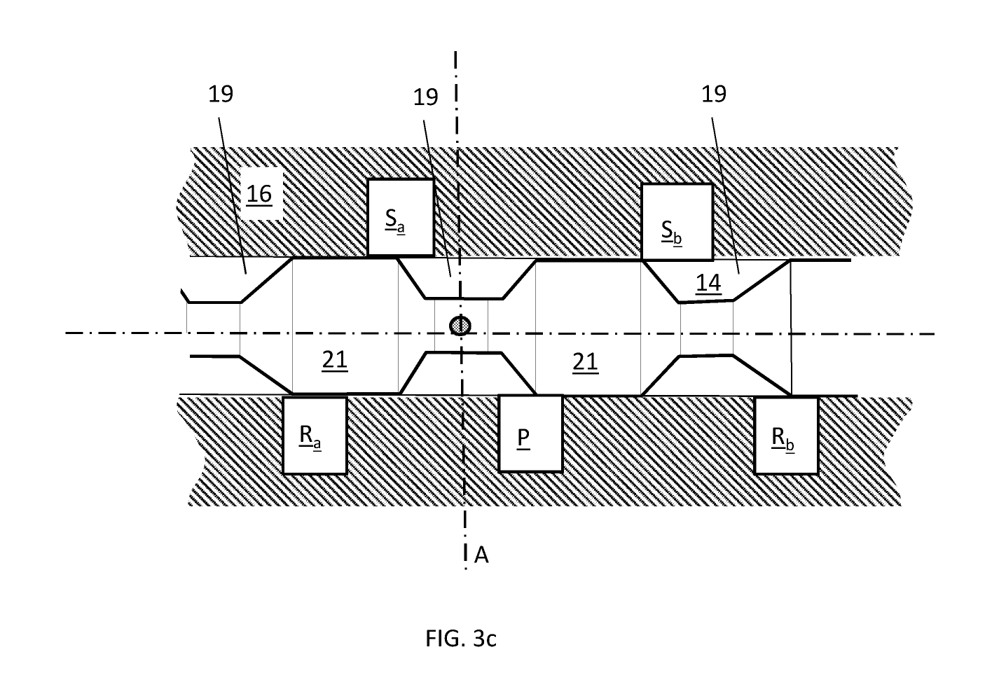

The main body of the actuator 4 includes a cavity 10. The actuator 4 also comprises an actuator arm 8. The lower end 8a of the actuator arm 8 (i.e. the end of the actuator arm 8 furthest from the chassis 3) is in the form of a piston head which divides the cavity 10 into two chambers; lower chamber 10a (the chamber furthest from the chassis) and upper chamber 10b (the chamber closest to the chassis). A service flow passage 12ₐ, 12_{b} extends between each chamber 10a, 10b and a corresponding service port Sₐ, S_{b} which forms part of a direct drive servo valve 16. The servo valve 16 is denoted by a dashed line in FIG. 2 and its internal structure is shown in more detail in FIG. 3. The servo valve 16 also comprises a moveable spool 18. On the opposite side of the spool 18 to the service ports Sₐ, S_{b} are two return ports Rₐ, R_{b} and a high-pressure port P. Both return ports Rₐ, R_{b} are connected via a low-pressure sub-system 20 with the input of a pump 22. A check valve 26ₐ, 26_{b} connects the low-pressure sub-system 20 with each service flow passage 12ₐ, 12_{b}. The high-pressure port P is connected via a high-pressure sub-system 28 with an accumulator 30 and the output of the pump 22. The system also comprises a bootstrap reservoir 32 comprising a bootstrap piston 34 extending between the high and low-pressure sub-systems 28, 20. The system further includes a control unit, a sensor, a spool motor and a pump motor which along with other elements of the system not mentioned here have been omitted from FIG. 2 for the sake of clarity.

In use, prior to the detection of any road event by the control system and sensors (not shown) the pump 22 is operated to move fluid from the low-pressure sub-system 20 to the accumulator 30 via the high-pressure sub-system 28. Once a target pressure of 20 MPa is reached in the high-pressure sub-system 28 the pump 22 is switched off. While waiting for a road event to occur the pump 22 is periodically reactivated to compensate for any quiescent leakage from the high-pressure sub-system 28 and maintain the high-pressure sub-system 28 at or near the target pressure. When a road event is detected the spool 18 is moved to provide ‘active’ or ‘semi-active’ suspension by allowing fluid to move between the actuator chambers 10a, 10b and the high-pressure 28 and/or low-pressure 20 sub-systems. During and after a road event the pump 22 is operated to supply high-pressure fluid to the high-pressure sub-system 28 in order to replenish that sub-system.

FIG. 3 shows a close up view of part of the spool valve 16 in accordance with the first embodiment. The spool valve comprises a spool 18 concentrically located within a cavity 14 formed in a manifold 15. The inner surface of the manifold 15 that defines the cavity 14 includes a plurality of internal ports of which only five are shown here for clarity. The inner surface of the manifold includes a pressure port P, two return ports Rₐ and R_{b}, and two service ports Sₐ and S_{b}. The ports are spaced apart along the length of the cylindrical spool 18. The mid-point of the spool 18 is denoted by a dashed line labelled A in FIG. 3. The pressure port P is shown located on the lower side of the spool 18 on the midline A in FIG. 3 Return ports Rₐ and R_{b} are located either side of the pressure port P on the left- and right-hand side of port P respectively. On the upper side of the spool 18, a service port Sₐ, S_{b} is located between each return port Rₐ, R_{b} and the central pressure port P. Each service port S is located closer (in terms of distance along the longitudinal axis of the spool) to a return port R than a high-pressure port P. The outer surface of the spool 18 includes three grooves 19 spaced between four lands 21 which are in contact with the inner surface of the manifold 15 which defines the cavity 14.

In use, when the spool is in the null position (as shown in FIG. 3(a)) a land 21 of the spool 18 closes off each service port S while each of the return and pressure ports R, P are aligned with a different one of the three grooves 19. With the spool in this position the only fluid that flows via the spool valve is the small amount that leaks around the side of the spool. Thus, active suspension systems in accordance with the present embodiment may have a lower rate of quiescent leakage from the high-pressure sub-system compared to active suspension systems incorporating other types of control valves.

Moving the spool to the left of the position shown in FIG. 3(b) uncovers a portion of the right-hand side service port S_{b} such that fluid may flow from the right hand service port S_{b} to the return port R_{b}. This allows fluid to flow from the upper actuator chamber 10ₐ to the low-pressure sub-system 20. The left hand service port Sₐ remains closed off by the land 21 in this intermediate position. The precise flow rate through the spool valve may be varied by controlling the extent to which the service port S_{b} is uncovered when the spool is in the intermediate position. In use this intermediate position may be used to slow the rate at which the wheel 3 moves towards the chassis 5 when the wheel is subject to an external force or to allow the wheel 3 to return downwards towards its normal position following a severe road event.

Continuing the movement of the spool 18 to the left to the position shown in FIG. 3(c) then uncovers the left-hand service port Sₐ such that fluid may flow from the high-pressure port P to the service port Sₐ via the central groove on the spool 18. Thus, fluid may flow from the high-pressure sub-system 28 to the lower chamber 10a of the actuator as well as from the higher chamber 10b of the actuator to the low-pressure sub-system 20 when the spool 18 is in this fully extended position. The resulting pressure imbalance in the actuator chambers 10 causes the wheel to be pulled upwards.

Similarly when moving the spool to the right, the spool first passes through an intermediate position in which a flow path exits between the left-hand side service port Sₐ and the left-hand return port Ra, while continued movement in that direction subsequently creates a flow path between the right-hand side return port S_{b} and the high-pressure port S_{b} (while maintaining the flow path between Sₐ and Rₐ). The fluid flow in the intermediate positions when the spool has been moved to the right results in a pressure imbalance in the actuator that acts to slow a movement of the wheel 5 away from the chassis 3 in response to an external force or allow the wheel 5 to return upwards towards its normal position following a severe road event. The fluid flow in the fully extended position when the spool has been moved to the right results in a pressure imbalance in the actuator that acts to move the wheel 5 away from the chassis 3 (i.e. pushes the wheel down).

In use, the active suspension system is operated in the ‘semi-active’ mode by moving the spool 18 between the null and intermediate position, and in the ‘active’ mode when the spool 18 is moved between the null and fully extended positions. Thus, in suspension systems in accordance with the present embodiment there is no need for a control system to actively switch the system between those two modes.

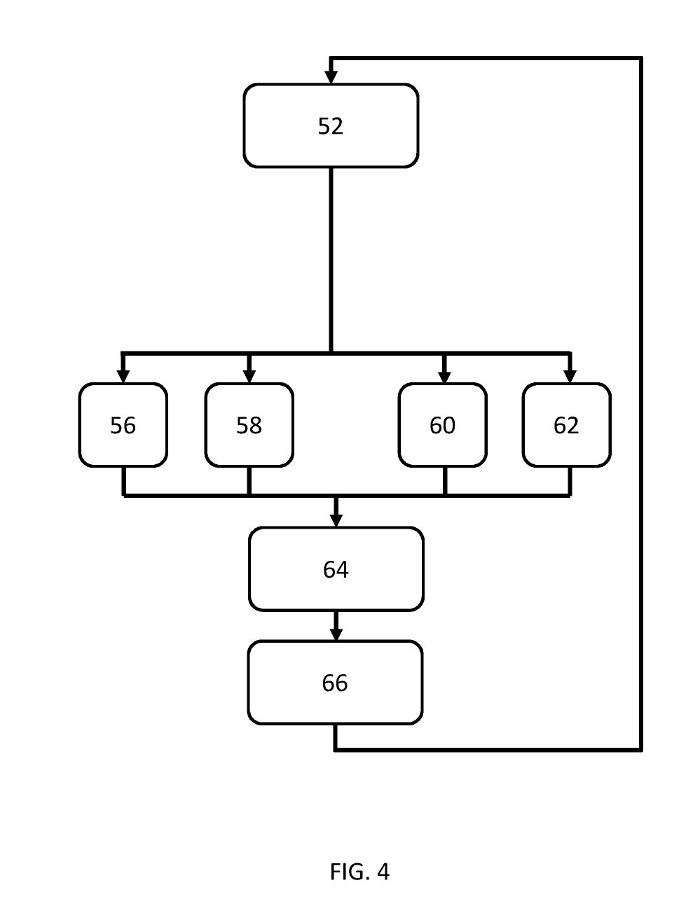

FIG. 4 shows a flow diagram of the process for controlling the movement of a car wheel using an active suspension. A road event is detected 52. When the road event is moderate the spool 18 is moved to the left intermediate position 56 or moved to the right intermediate position 58 such that fluid may escape from one or other of the actuator chambers. Thus, active suspension systems in accordance with the present embodiment may function in a semi-active mode without using fluid from the high-pressure sub-system, thereby improving the energy efficiency of the system.

When the road event is categorised as severe the spool 18 is moved to the far left 60 or far right 62 positions such that fluid may move between the actuator and both the high-pressure and low-pressure sub-systems. Thus, active suspension systems in accordance with the present embodiment may switch between active and semi-active modes simply by increasing the distance travelled by the spool.

Following the road event the spool returns to the null position 64. When the road event was severe, the spool returns to the null position via the appropriate intermediate position in order to allow the wheel to return to its normal position. The pump is then operated to return the pressure in the high-pressure sub-system to its normal value (if necessary). The pump is then operated periodically 66 to maintain the pressure in the high-pressure sub-system at its normal value.

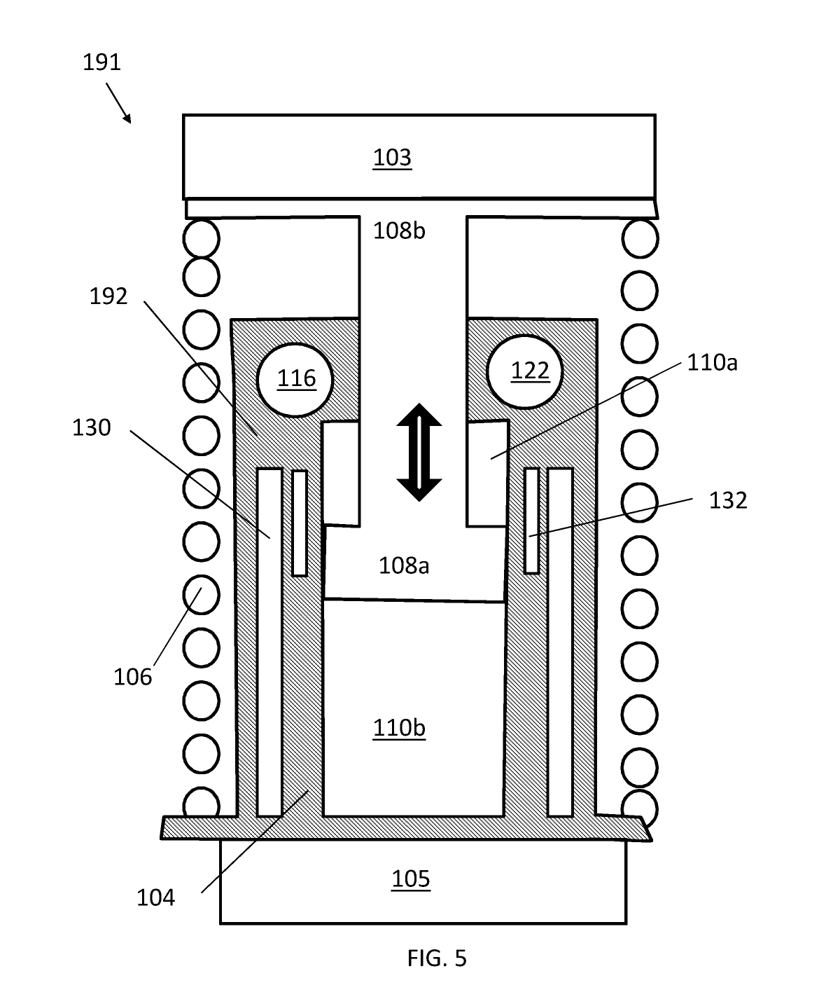

FIG. 5 shows a cross-sectional view of a strut 191 in accordance with a second example embodiment of the invention. The strut 191 comprises a main housing 192 concentrically located with a coil spring 106 and attached at one end to the chassis 103 of a car and at the other end to the wheel 105 of a car. Within the main housing 192 is an actuator cavity 110 in which one end of an actuator arm 108 is located. Concentrically located around the actuator chamber 110 is a first cavity forming part of a bootstrap reservoir 132 and a second cavity forming part of an accumulator 130. A control valve 116 and pump 120 are also located within, and formed at least in part by, the main housing of the strut 191. Flow galleries (not shown) in the main housing 192 link the components. The main housing 192 of the strut is produced using an additive manufacturing process. Other aspects of the active suspension system are as described above.

Providing several components of the active suspension system in a strut means active suspension systems in accordance with the present invention may be easier to install and maintain and/or more compact.

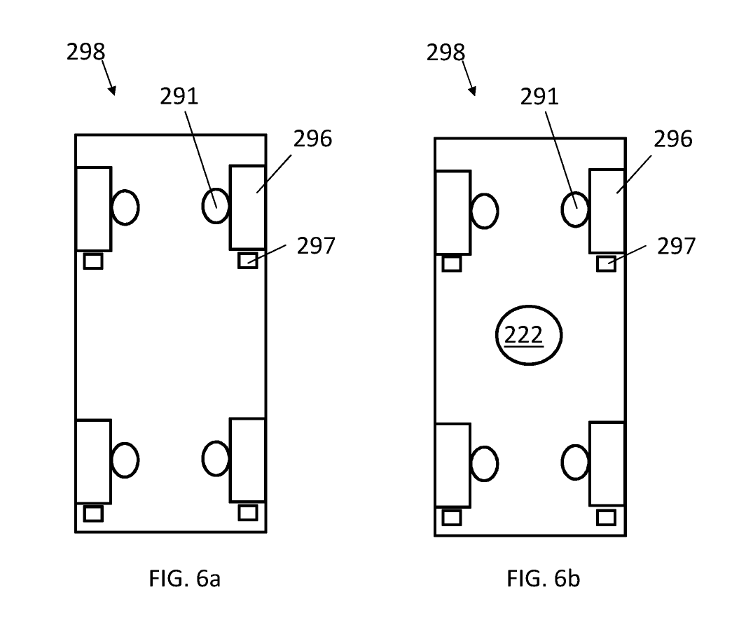

FIG. 6 (a) shows a schematic view of the underside of a car 298 including an active suspension system in accordance with further embodiments of the invention. The car has four wheels 296. A strut 291, substantially as described with reference to FIG. 5, connects each wheel 296 to the chassis (not shown) of the car 298. A first accelerometer 297 is located forward of each wheel 296 and supplies information to the centrally located control system (not shown) of the car 298. A second accelerometer (not shown) is connected to each wheel 296 and also supplies information to the centrally located control system. The control system controls the movement of the spool of each strut 291 in response to the difference in acceleration measured by the two accelerometers 297 associated with each wheel 296.

FIG. 6 (b) shows a schematic view of the underside of a car 298 including an active suspension system. In contrast to the embodiment of FIG. 6 (a), the system of FIG. 6 (b) has a centrally located pump 222 which supplies fluid to accumulators 230 which are formed in a strut 291, wherein each strut connects a wheel 296 to the chassis (not shown) of the car 298.

Whilst the present invention has been described and illustrated with reference to particular embodiments, it will be appreciated by those of ordinary skill in the art that the invention lends itself to many different variations not specifically illustrated herein. By way of example only, certain possible variations will now be described. For example, while the above embodiments all comprise a servo valve, other types of control valve may be used. Alternatively, a servo valve (or other control valve) may be used with an active suspension system in which fluid is supplied to the valve by a pump without passing through an accumulator. The pump and control valve may be provided as a single component, produced using an additive manufacturing process and located locally to each strut.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. An active suspension system for a vehicle, the suspension system comprising a hydraulic actuator for connection to the vehicle, an accumulator arranged to provide fluid to the actuator and a spool valve comprising a spool mounted for movement between a first position in which the flow of fluid from the accumulator to the actuator is prevented and a second position in which fluid can flow from the accumulator to the actuator via the spool thereby causing movement of the actuator.

2. An active suspension system according to claim 1, wherein the accumulator forms part of a high-pressure sub-system and the suspension system further comprises a low-pressure sub-system, and wherein fluid can flow from the hydraulic actuator to the low-pressure sub-system via the spool when the spool is in the second position.

3. An active suspension system according to claim 2, wherein the spool is mounted for movement between the first position and a third position in which fluid can flow from the hydraulic actuator to the low-pressure sub-system via the spool and wherein the flow of fluid from the high-pressure sub-system to the hydraulic actuator is prevented by the spool when the spool is in the third position.

4. An active suspension system according to claim 3, wherein the spool passes through the third position when the spool moves from the first position to the second position.

5. An active suspension system according to claim 1, wherein the suspension system comprises a pump arranged to provide fluid to the accumulator.

6. An active suspension system according to claim 5, wherein the accumulator is located on a flow path between the pump and the spool valve.

7. An active suspension system according to claim 1, wherein the spool valve is a direct drive spool valve.

8. An active suspension system according to claim 1, wherein the spool valve is an Electro-Hydraulic Servo Valve.

9. An active suspension system according to claim 1, wherein the spool valve includes a plurality of internal ports spaced apart along the longitudinal axis of the spool, and the ports and spool are arranged such that the distance that the spool must move in a given direction to create a flow path between a service port and the corresponding return port is less than the distance the spool must move in the same direction to create a flow path between another service port and its corresponding high-pressure port.

10. An active suspension system according to claim 1, wherein the control system is arranged to alter the target position of the actuator arm from a first target position to a second target position thereby changing the ride height of the vehicle.

11. A method of actively controlling the suspension of a vehicle using an active suspension system, the suspension system comprising a spool valve including a spool, an accumulator and a hydraulic actuator, the method comprising the step of moving the spool from a first position to a second position to alter the flow of fluid to the actuator from the accumulator in response to a road event.

12. A method of actively controlling the suspension of a vehicle according to claim 11, wherein the suspension system further comprises a pump and the method includes operating the pump to provide pressurised fluid to the accumulator while the spool is in the first position.

13. A method of actively controlling the suspension of a vehicle according to claim 11, wherein the method includes the step of using an additive manufacturing process to make at least part of the active suspension system.

14. A method of controlling the movement of a wheel of a vehicle using an active suspension system comprising a hydraulic actuator suitable for connection between the wheel and the chassis of the vehicle, a control valve arranged to control the flow of fluid to the actuator, an accumulator in fluid communication with the control valve and a pump arranged to provide fluid to the accumulator, the method comprising moving the control valve from a closed position in which fluid cannot flow from the accumulator to the actuator to an open position in which fluid can flow from the accumulator to the actuator via the valve in response to a road event, and wherein the method further includes operating the pump to provide high pressure fluid to the accumulator when the control valve is in the closed position.

15. A method of controlling the movement of a wheel in accordance with claim 14, wherein the accumulator forms part of a high-pressure sub-system and the method comprises the step of periodically operating the pump to provide fluid to the accumulator when the control valve is in the closed position in order to maintain pressure in the high-pressure sub-system.

16. An active suspension system for a vehicle, the active suspension system comprising a hydraulic actuator for connection between a wheel and the chassis of the vehicle, a control valve arranged to control the flow of fluid to the actuator, a high pressure sub-system including an accumulator in fluid communication with the control valve and a pump arranged to provide high pressure fluid to the high pressure sub-system.

17. An active suspension system according to claim 16, wherein the control valve is a spool valve.

18. A strut for connection between a chassis and a wheel of a vehicle wherein the strut comprises a main housing, the main housing forming at least part of one of the components of the active suspension system according to claim 1.

19. A vehicle including an active suspension system in accordance with claim 1.
